(19) United States
(12) Patent Application Publication
(10) Pub. No.: US 2011/0232381 A1
(43) Pub. Date: Sep. 29, 2011

(54) System for monitoring liquid level in underground storage tank

(76) Inventors: Munir A. Al-Absi, Dhahran (SA); Eyas Saleh Al-Suhaibani, Jobile (SA)

(21) Appl. No.: 12/659,940

(22) Filed: Mar. 25, 2010

(51) Int. Cl. G01F 23/296

(52) U.S. Cl. 73/290 V

(57) ABSTRACT

The system for monitoring a liquid level in an underground storage tank provides an external visual indication of a liquid level, such as water level, within a sealed underground storage tank. The system includes an ultrasonic transducer for generating regularly pulsed ultrasonic signals and for receiving reflected ultrasonic signals, which are reflected from a surface of the liquid stored in the underground storage tank. A pulser connected to a timer is in communication with the ultrasonic transducer for generating regularly pulsed ultrasonic signals. The timer is further used to measure the time period between generation of one of the pulsed ultrasonic signals and reception of the corresponding reflected ultrasonic wave. The height between the ultrasonic transducer and the liquid surface is then calculated based upon the measured time period. The liquid level is then displayed to the user on an external display.

### BACKGROUND OF THE INVENTION

1. Field of the Invention

The present invention relates to apparatus for measuring the level of a liquid in a tank, and particularly to a system for monitoring liquid level in an underground storage tank that uses ultrasonic measurement apparatus.

2. Description of the Related Art

There is a continuing need to monitor the level of liquid in an in-ground, or underground, liquid storage tank. Such underground liquid storage tanks are typically employed for storage of liquid from the time of delivery until use. Such storage tanks are also used for temporary storage of liquid at a wholesaler's location from the time of receipt until it is removed for delivery to a retailer, or at a retail location from the time of delivery until sale to the customer. Such underground storage tanks are typically formed as cylinders having a substantially vertical fill pipe connecting the tank interior to a surface tank inlet permitting the tank to be filled. In the Kingdom of Saudi Arabia, for example, such underground tanks for residential villas and houses are commonly formed from cubical concrete.

It is necessary to periodically monitor the liquid level in such underground storage tanks for a variety of reasons. Primarily, in the case of tanks where the outlet of liquid is unmetered, there exists a need to determine the liquid level within the tank. In addition, even if the outlet of the tank is metered, it is necessary to periodically check the liquid level within the tank in order to ensure the accuracy of the inflow and outflow metering. Further, it is advisable to periodically independently determine the liquid level within a tank in order to determine whether or not the tank is leaking.

Even with metered inflows and outflows, such liquid level measurement is required for leak detection. Such leak detection is particularly desirable in the case in which the liquid stored in the storage tank is some hazardous or potentially hazardous material. Commonly, there exist environmental regulations requiring the owners or users of such in-ground liquid storage tanks to periodically test for leaks. As a consequence, it is desirable test the liquid level within such tanks.

Environmental protection considerations have made necessary the monitoring of liquid levels in underground storage tanks for petrochemical fuels and the like. A typical underground storage tank for liquid fuel storage is a cylinder having a length of approximately 21 feet and a diameter of approximately 8 feet. Current Environmental Protection Agency (EPA) regulations require that the owners of such fuel storage tanks monitor for fuel leaks with fuel loss rates as low as 0.10 gallons per hour. Leak rates this small in conventional tanks translate into a change in depth as small as 0.001 inches per hour.

The testing of liquid level is commonly performed either manually or electronically. Manual testing utilizes a dipstick or the like, physically dipped into the tank to directly observe the liquid level. Electronic monitoring utilizes sensors positioned within the tank, such as capacitance or conductive sensors. Such in-tank electronic liquid level sensors are, however, typically very expensive and require a large amount of time to mount in an existing tank. Further, the electronic components are often quite delicate and subject to corrosion or degradation due to the presence of the liquid in the tank. Given these considerations, such systems are expensive and difficult to retrofit into existing tanks.

Thus, a system for monitoring liquid level in an underground storage tank solving the aforementioned problems is desired.

### SUMMARY OF THE INVENTION

The system for monitoring liquid level in an underground storage tank provides an external visual indication of a liquid level, such as water level or oil level, within a sealed underground storage tank. The system includes an ultrasonic generator for generating regularly pulsed ultrasonic signals and a receiver or sensor for receiving reflected ultrasonic signals, which are reflected from a surface of the liquid stored in the underground storage tank. Preferably, both the generator and the receiver or sensor are provided in the form of a single ultrasonic transducer, such as a piezoelectric transducer or the like.

A pulser connected to a timer is in electrical communication with the piezoelectric transducer for generating regularly pulsed ultrasonic signals. The timer is further used to measure the time period between generation of one of the pulsed ultrasonic signals and reception of the corresponding reflected ultrasonic signal. Given the constant speed of sound within the air above the liquid surface in the tank, the height between the ultrasonic transducer and the surface of the liquid can be calculated based upon the measured time period. The liquid level is then displayed to the user on an external display.

These and other features of the present invention will become readily apparent upon further review of the following specification.

### BRIEF DESCRIPTION OF THE DRAWINGS

FIG. 1 is a diagrammatic view of a system for monitoring liquid level in an underground storage tank according to the present invention.

FIG. 2 is a schematic diagram of the system for monitoring liquid level in an underground storage tank of FIG. 1.

Similar reference characters denote corresponding features consistently throughout the attached drawings.

### DETAILED DESCRIPTION OF THE PREFERRED EMBODIMENTS

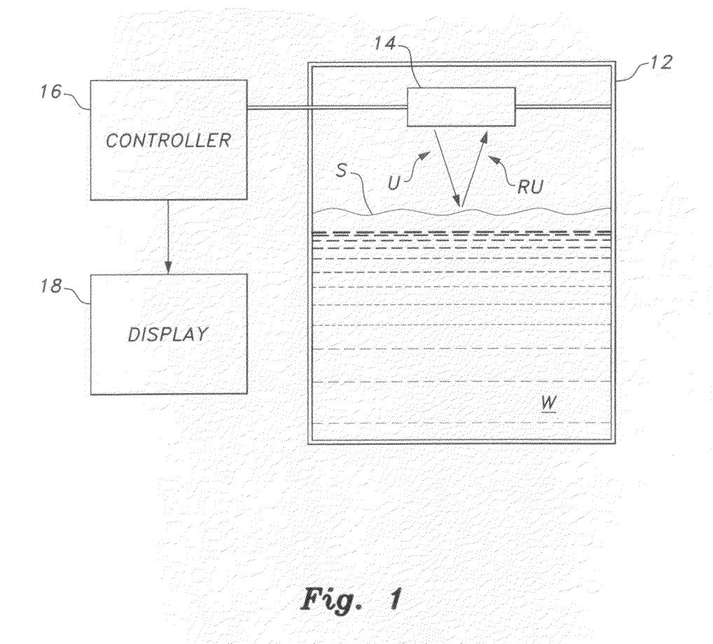

Referring to FIG. 1, the system 10 for monitoring liquid level in an underground storage tank 12 an external visual indication of the level of liquid, such the level of water W, within the sealed underground storage tank 12. It should be understood that the system 10 may be used to measure the level any desired type of liquid, including water, oil, gasoline, etc. The system 10 includes an ultrasonic generator for generating regularly pulsed ultrasonic signals U and a receiver or sensor for receiving ultrasonic signals RU reflected from the surface S of the liquid W stored in the underground storage tank 12. Preferably, both the generator and the receiver or sensor are provided in the form of a single ultrasonic transducer 14, such as a piezoelectric transducer or the like. A controller 16 is in communication with the ultrasonic transducer 14, providing control signals for the generation of regularly pulsed ultrasonic signals U, and for the conditioning and analysis of the reflected signals RU.

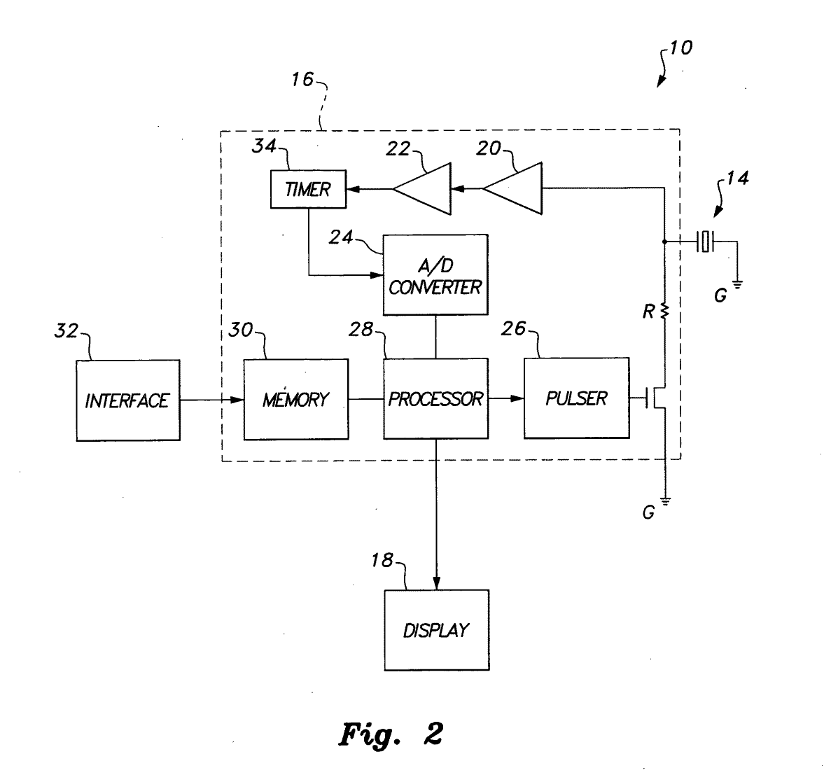

As best shown in FIG. 2, the controller 16 includes a pulser 26 connected directly or indirectly to a timer 34, which is in electrical communication with the piezoelectric transducer 14 for generating regularly pulsed ultrasonic signals U. Pulsing circuits for generating periodic pulse signals, such as square-wave signals, are well known in the art, and the pulser 26 may be any suitable type of pulsing circuit. Similarly, timing circuits are well known in the art, and the timer 34 may be any suitable type of clock or timing circuit.

Preferably, the controller 16 also includes a processor 28. The timer 34 may be a part of the processor 28, or may be in communication with the processor 28 for calculating the time period between generation of one of the pulsed ultrasonic signals U and reception of the corresponding reflected ultrasonic signal RU. Given the constant speed of sound within the air above the liquid surface S in the tank 12, the height between the ultrasonic transducer 14 and the surface S of the liquid can be calculated based upon the measured time period. The liquid level is then displayed to the user on an external display 18.

Data may be entered into the system 10 by the user via any suitable type of user interface 32, and may be stored in computer-readable memory 30, which may be any suitable type of computer readable and programmable memory. Calculations are performed by the processor 28, which may be any suitable type of computer processor, and may be displayed to the user on the display 18, which may be any suitable type of computer display.

The processor 28 may be associated with, or incorporated into, any suitable type of computing device, for example, a personal computer or a programmable logic controller. The display 18, the processor 28, the memory 30, and any associated computer readable media are in communication with one another by any suitable type of data bus, as is well known in the art.

Examples of computer readable media include a magnetic recording apparatus, an optical disk, a magneto-optical disk, and/or a semiconductor memory (for example, RAM, ROM, etc.). Examples of magnetic recording apparatus that may be used in addition to memory 30, or in place of memory 30, include a hard disk device (HDD), a flexible disk (FD), and a magnetic tape (MT). Examples of the optical disk include a DVD (Digital Versatile Disc), a DVD-RAM; a CD-ROM (Compact Disc-Read Only Memory), and a CD-R (Recordable)/RW.

The pulsed electrical signals generated by the pulser 26 under the control of the processor 28 and the timer 34 are transmitted to the ultrasonic transducer 14, and may be conditioned by use of any necessary components, such as additional resistors R or the like. The transducer 14 and the pulser 26 are grounded at G, as is conventionally known.

The ultrasonic transducer 14 generates signals representing the reflected ultrasonic signals RU, which are passed to a preamplifier 20 and then to a high gain amplifier 22 for conditioning and amplification thereof. Preferably, the amplified signal is then passed to an analog-to-digital converter 24, allowing the digitized signals to be recorded in computer readable memory 30 as data representing the reflected ultrasonic signals. The processor 28, in communication with timer 34, measures the time period between one of the pulsed ultrasonic signals U and reception of the reflected signal RU. The distance between the transducer 14 and the liquid surface S is then calculated based upon this time period, and this distance, representing the liquid level in the tank 12 measured from the ultrasonic transmitting and receiving apparatus 14, is transmitted to the display 18, which may be any suitable type of display, such as a liquid crystal display or the like. Alternatively, or in addition, this distance can be converted to the depth of the liquid in the tank 12 by subtraction from the depth of the tank 12 as measured between the ultrasonic transmitting and receiving apparatus 14 and the bottom of the tank 12, or into the volume of liquid in the tank 12 given the depth of the liquid in the tank 12.

It is to be understood that the present invention is not limited to the embodiments described above, but encompasses any and all embodiments within the scope of the following claims.

We claim:

1. A system for monitoring liquid level in an underground storage tank, comprising:
means for generating regularly pulsed ultrasonic signals towards the surface of a liquid in the underground storage tank;
means for receiving ultrasonic waves representing reflections of the pulsed ultrasonic signals from the surface of the liquid and converting the received ultrasonic waves into received ultrasonic signals corresponding to the pulsed ultrasonic signals;
means for measuring the time period between generation of one of the pulsed ultrasonic signals and reception of the corresponding received ultrasonic signal;
means for calculating the level of the liquid stored in the underground storage tank based upon the measured time period; and
means for displaying the liquid level to a user.

2. The system for monitoring liquid level as recited in claim 1, wherein said means for generating regularly pulsed ultrasonic signals and said means for receiving ultrasonic waves and converting the waves into received ultrasonic signals comprises a piezoelectric transducer.

3. The system for monitoring liquid level as recited in claim 2, wherein said means for generating regularly pulsed ultrasonic signals comprises a pulser in electrical communication with the piezoelectric transducer.

4. The system for monitoring liquid level as recited in claim 3, wherein said means for generating regularly pulsed ultrasonic signals further comprises a timer connected to the pulser.

5. The system for monitoring liquid level as recited in claim 3, wherein said means for receiving reflected ultrasonic waves and converting the reflect waves into a received ultrasonic signal further comprises a preamplifier in electrical communication with the piezoelectric transducer.

6. The system for monitoring liquid level as recited in claim 5, wherein said means for receiving reflected ultrasonic waves and converting the reflect waves into a received ultrasonic signal further comprises a high gain amplifier in electrical communication with the preamplifier.

7. The system for monitoring liquid level as recited in claim 6, wherein said means for receiving reflected ultrasonic waves and converting the reflect waves into a received ultrasonic signal further comprises an analog-to-digital converter in electrical communication with the high gain amplifier.

8. The system for monitoring liquid level as recited in claim 7, wherein the analog-to-digital converter outputs a digital signal representing the liquid level, the digital signal being transmitted to said means for displaying the liquid level.

9. The system for monitoring liquid level as recited in claim 8, further comprising computer readable memory, the analog-to-digital converter being in electrical communication with the computer readable memory for storing data representing the liquid level therein.
